(19) United States
(12) Patent Application Publication
(10) Pub. No.: US 2025/0093675 A1
(43) Pub. Date: Mar. 20, 2025

(54) OPTICAL ELEMENT DRIVING MECHANISM

(71) Applicant: TDK TAIWAN CORP., Taoyuan City (TW)

(72) Inventors: Po-Xiang ZHUANG, Taoyuan City (TW); Jui-Ta CHIEN, Taoyuan City (TW); Wei-Jhe SHEN, Taoyuan City (TW); Yi-Ho CHEN, Taoyuan City (TW); Shou-Jen LIU, Taoyuan City (TW); Kun-Shih LIN, Taoyuan City (TW)

(21) Appl. No.: 18/884,368

(22) Filed: Sep. 13, 2024

Related U.S. Application Data
(60) Provisional application No. 63/583,067, filed on Sep. 15, 2023.

(51) Int. Cl. G02B 27/64; G03B 5/00

(52) U.S. Cl. CPC G02B 27/646; G03B 5/00; G03B 2205/0007; G03B 2205/0069

(57) ABSTRACT

An optical element driving mechanism is provided. The optical element driving mechanism is for driving an optical element. The optical element includes a movable part, a fixed part, and a driving assembly. The movable part may move relative to the fixed part. The driving assembly drives the movable part to move.

### CROSS REFERENCE TO RELATED APPLICATIONS

This application claims the benefit of U.S. Provisional Application No. 63/583,067, filed 2023 Sep. 15, the entirety of which is incorporated by reference herein.

### BACKGROUND OF THE INVENTION

### Field of the Invention

The present invention relates to an optical element driving mechanism, and, in particular, to a driving assembly including multiple magnetic elements and coils.

### Description of the Related Art

With the development of technology, many electronic devices today (such as laptops, smartphones, and digital cameras) have such functionality as taking photographs and recording video. The use of these electronic devices is becoming increasingly common. While development is trending towards more stability and better optical quality, there is also a trend towards convenient and thin designs to provide users with more options.

In view of this, there is a need for an optical element driving mechanism that allows adjustment of optical focusing to meet the different needs of outdoor photography. At the same time, it should reduce operational errors caused by interference with magnetic elements, stabilize the internal structure, and provide optical quality that is better and more stable.

### BRIEF SUMMARY OF THE INVENTION

The term embodiment and like terms, e.g., implementation, configuration, aspect, example, approach, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, an optical element driving mechanism for driving an optical element is disclosed. The optical element driving mechanism includes a fixed part, a movable part, and a driving assembly. The movable part moves relative to the fixed part. The driving assembly drives the movable part to move.

According to certain aspects of the present disclosure, the optical element driving mechanism further comprising a supporting assembly, corresponding to the movable part. The supporting assembly includes a first middle element, and a first supporting element. The first middle element having a magnetic material, or a metal material, or both. The first supporting element, the first supporting element moves relative to the first middle element. The first supporting element has a first supporting surface and a side surface. The first supporting surface contacts the first middle element, and faces a first direction. The side surface is adjacent to the first supporting surface. The side surface is not parallel to the first supporting surface.

According to certain aspects of the present disclosure, when viewed along a direction perpendicular to the first supporting surface, one side of the first supporting surface connects the side surface. An open space is on the other side of the first supporting surface. The first supporting element does not have a surface facing the opposite direction of the side surface.

According to certain aspects of the present disclosure, the supporting assembly further includes a first force application element. The first force application element has a magnetic material for generating a first contact force to keep the first supporting element in continuous contact with the first middle element, the direction of the first contact force is perpendicular to the first supporting surface, wherein a first axis is parallel to the first supporting surface and the side surface.

According to certain aspects of the present disclosure, the supporting assembly further includes a second middle element, a second supporting element. There is a gap between the second supporting element and the second middle element. The second supporting element and the second middle element move relative to each other. The first supporting element and the second supporting element have an integrally formed structure. The second supporting element includes a second supporting surface and a third supporting surface. The second supporting surface contacts the second middle element, and faces a second direction. The third supporting surface contacts the second middle element, and faces a third direction. The second supporting surface is not parallel to the third supporting surface.

According to certain aspects of the present disclosure, the angle between the first direction and the second direction is different from the angle between the first direction and the third direction.

According to certain aspects of the present disclosure, the supporting assembly further includes a second force application element. The second force application element generates a second contact force to keep the second supporting element in continuous contact with the second middle element, the direction of the second contact force is non-parallel and non-perpendicular to the second supporting surface. The direction of the first contact force is different from the direction of the second contact force.

According to certain aspects of the present disclosure, when viewed along the first axis, the distance from the center of the second supporting surface to the center of the optical element is greater than the distance from the center of the third supporting surface to the center of the optical element. The arrangement direction of the center of the first middle element and the center of the first force application element is different from the arrangement direction of the center of the second middle element and the center of the second force application element.

According to certain aspects of the present disclosure, the supporting assembly further includes a first surface, a second surface, a first accommodation part, a second accommodation part, and a fixed element. The first surface is parallel to the first axis. The first surface and the second surface face different directions, the second surface is perpendicular to the first axis. The first accommodation part is formed on the first surface, accommodating the first force application element. The second accommodation part, formed on the second surface, accommodating the second force application element. The fixed element is disposed on the second surface and fixedly connected to the movable part. The fixed element has a stopper part to limit the movement range of the movable part, the stopper part has a protruding structure.

According to certain aspects of the present disclosure, when viewed along a direction perpendicular to the second surface, the fixed element at least partially overlaps the second accommodation part. The angle between the first direction and the second direction is smaller than the angle between the first direction and the third direction.

According to certain aspects of the present disclosure, the fixed part further includes a first opening, light passes through the first opening to the optical element.

According to certain aspects of the present disclosure, the fixed part further includes a second opening. The optical element driving mechanism further includes a circuit assembly for connecting an external circuit, the circuit assembly includes a first electrical connection part, a first circuit element, a second electrical connection part, and a contact point. The first electrical connection part at least partially exposed through the first opening. The first circuit element is electrically connected to the first electrical connection part. The driving assembly is electrically connected to the first electrical connection part through the first circuit element. The second electrical connection part is at least partially exposed through the second opening. The second electrical connection part is electrically connected to the first electrical connection part through the first circuit element. The driving assembly is electrically connected to the second electrical connection part through the first circuit element. The contact point corresponds to a protrusion of the movable part.

According to certain aspects of the present disclosure, the external circuit includes a first external assembly and a second external assembly, the first electrical connection part being electrically connected to the first external assembly, and the second electrical connection part being electrically connected to the second external assembly. The shortest distance between the second electrical connection part and the first opening is different from the shortest distance between the first electrical connection part and the first opening. The first electrical connection part moves relative to the second electrical connection part.

According to certain aspects of the present disclosure, the driving assembly further includes a driving part and a control unit. The driving part generates a driving force, and is fixedly connected to the movable part, and electrically connected to the first circuit element through the contact point. The control unit outputs a driving signal to the driving part, and is fixedly connected to the fixed element, wherein the first circuit element is electrically connected to the control unit through the first electrical connection part.

According to certain aspects of the present disclosure, the circuit assembly further includes a second circuit element, at least partially embedded in the fixed element.

According to certain aspects of the present disclosure, the fixed element has a recessed part for accommodating the control unit, the control unit has a plate-like structure. The depth of the recessed part is greater than the thickness of the control unit. When viewed along the first axis, the recessed part at least partially overlaps the stopper part, and the contact point is formed on the second circuit element.

According to certain aspects of the present disclosure, the circuit assembly further includes a third circuit element and a fourth circuit element. The third circuit element has an elongated structure, and is electrically connected to the first circuit element. The fourth circuit element, having an elongated structure, and is electrically connected to the first circuit element. The third circuit element is electrically connected to the fourth circuit element through the first circuit element.

According to certain aspects of the present disclosure, when viewed along the first axis, the third circuit element and the fourth circuit element do not overlap.

According to certain aspects of the present disclosure, the extension direction of the third circuit element is parallel to the extension direction of the fourth circuit element.

According to certain aspects of the present disclosure, the optical element driving mechanism further includes a vibration suppression element, directly contacting the third circuit element and the fourth circuit element, having a resin material. The circuit assembly further includes a fifth circuit element, the driving part is electrically connected to the control unit through the fifth circuit element. The contact point is formed on the third circuit.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below . . .

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a front perspective view of the optical element driving mechanism and an optical element, according to certain aspects of the present disclosure.

FIG. 2 is an exploded perspective view of the optical element driving mechanism and the optical element, according to certain aspects of the present disclosure.

FIG. 3 is a top view of the optical element driving mechanism, according to certain aspects of the present disclosure. For illustrative purposes, the housing is not shown.

FIG. 4 is a top view of the optical element driving mechanism, according to certain aspects of the present disclosure. For illustrative purposes, the housing is not shown, and parts of the main body and the supporting element are shown in dashed lines.

FIG. 5 is a bottom view of the optical element driving mechanism, according to certain aspects of the present disclosure. For illustrative purposes, the fixed part is not shown.

FIG. 6 is a side view of the optical element driving mechanism, according to certain aspects of the present disclosure. For illustrative purposes, the housing is not shown, and the frame is shown in dashed lines.

FIG. 7 is a block diagram of the external circuit and the circuit assembly of the optical element driving mechanism, according to certain aspects of the present disclosure.

FIG. 8 is a top view of another optical element driving mechanism, according to another aspect of the present disclosure. For illustrative purposes, the housing is not shown, and the frame is shown in dashed lines.

### DETAILED DESCRIPTION OF THE INVENTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features may be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended patent application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

The present disclosure relates to an optical element driving mechanism, wherein the driving assembly has multiple sets of coils and magnetic elements, driving the movable part and optical element to move flexibly in various directions, thereby adjusting the imaging of the optical element driving mechanism to accommodate different photographing needs.

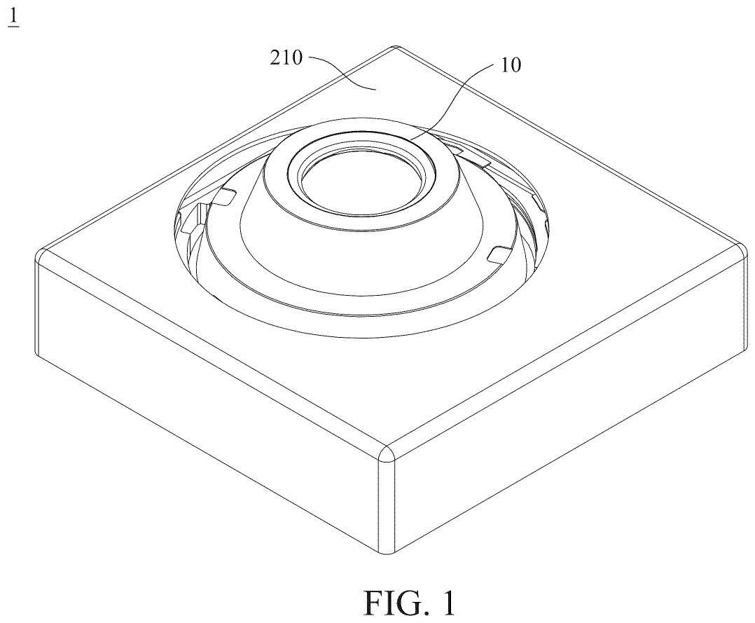

First, refer to FIG. 1. FIG. 1 is a front perspective view of the optical element driving mechanism 1 and an optical element 10, according to certain aspects of the present disclosure.

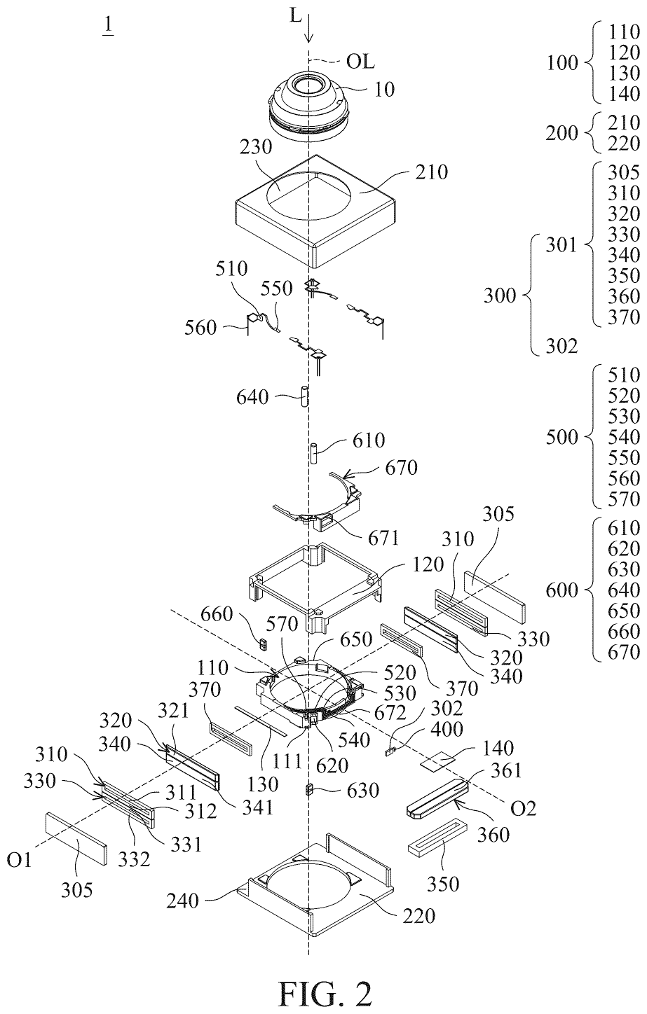

Please refer to FIG. 2. FIG. 2 is an exploded perspective view of the optical element driving mechanism 1 and the optical element 10, according to certain aspects of the present disclosure. The optical element driving mechanism 1 includes a movable part 100, a fixed part 200, a driving assembly 300, a position sensing assembly 400, a circuit assembly 500, and a supporting assembly 600.

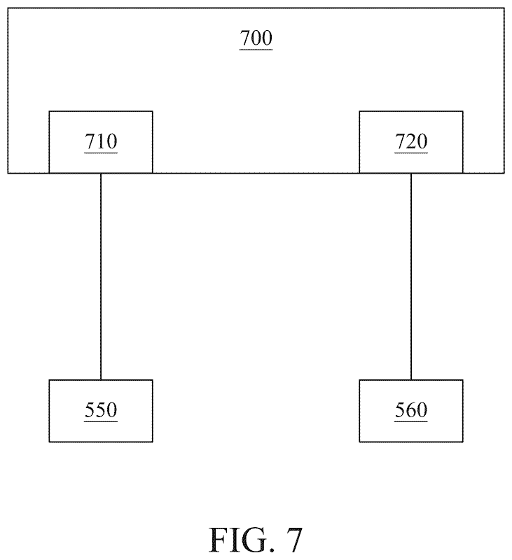

The movable part 100 connects to the optical element 10, which may be, for example, an optical lens. The movable part 100 may move relative to the fixed part 200, and the driving assembly 300 drives the optical element 10 to move relative to the fixed part 200. The position sensing assembly 400 is for sensing the movement of the optical element 10. The circuit assembly 500 is connected to an external circuit 700 (shown in FIG. 7). The supporting assembly 600 corresponds to the movable part 100. The supporting assembly 600 supports the movement of the movable part 100 relative to the fixed part 200.

The movable part 100 includes a main body 110, a frame 120, and two magnetically permeable plates 130 and 140.

The movable part 100 accommodates the optical element 10. The main body 110 has a protrusion 111, which corresponds to a part of the circuit assembly 500. The main body 110 contacts the frame 120 through the supporting assembly 600, so the main body 110, the supporting assembly 600, and the optical element 10 may move relative to the frame 120 (as will be described below in detail with respect to the supporting assembly 600 and the driving assembly 300). The two magnetically permeable plates 130 and 140 are positioned respectively above a first magnetic element 320 and a third magnetic element 360 of the driving assembly 300, which may prevent magnetic field interference between multiple magnetic elements.

The fixed part 200 includes a housing 210, a base 220, a first opening 230, and a second opening 240. A light beam L enters the optical element 10 through the first opening 230. The housing 210 and the base 220 are fixedly connected to accommodate other elements of the optical element driving mechanism 1 and the optical element 10.

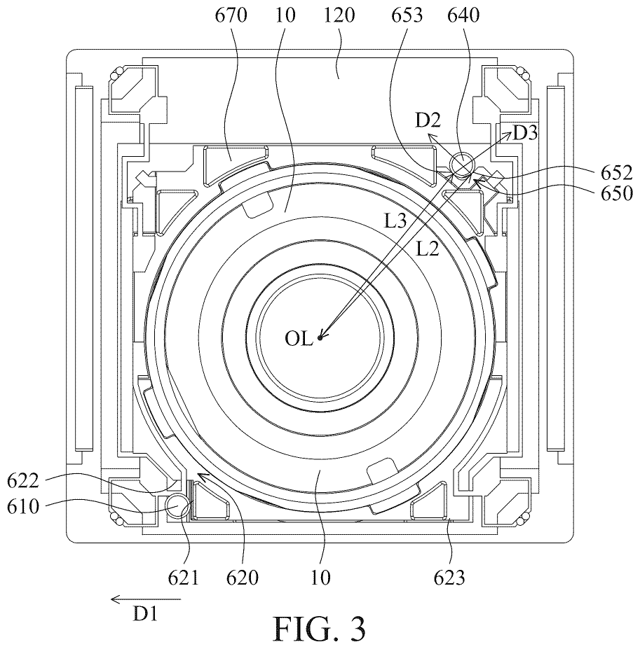

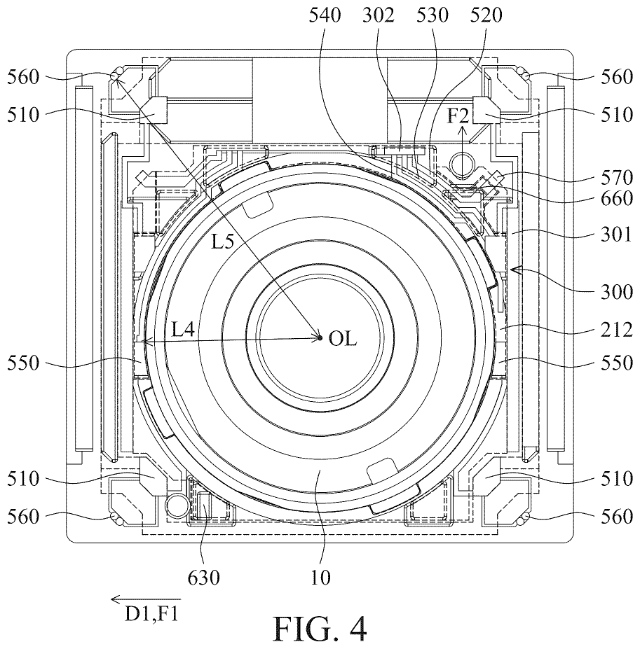

Next, please refer to FIGS. 2, 3, and 4 together. FIG. 3 is a top view of the optical element driving mechanism 1, according to certain aspects of the present disclosure. For illustrative purposes, the housing 210 is not shown. FIG. 4 is a top view of the optical element driving mechanism 1, according to certain aspects of the present disclosure. For illustrative purposes, the housing 210 is not shown, and parts of the main body 110 and the supporting assembly 600 are shown in dashed lines.

The supporting assembly 600 includes a first middle element 610, a first supporting element 620, a first force application element 630, a second middle element 640, a second supporting element 650, a second force application element 660, and a fixed element 670.

The first middle element 610 and the second middle element 640 have magnetically permeable material, or metal material, or both. The first supporting element 620 has a first supporting surface 621 and a side surface 622, which may move relative to the first middle element 610. The first supporting surface 621 contacts the first middle element 610. The first supporting surface 621 faces a first direction D1, and the side surface 622 is adjacent to the first supporting surface 621. The side surface 622 is not parallel to the first supporting surface 621. When viewed along a direction perpendicular to the first supporting surface 621, one side of the first supporting surface 621 connects to the side surface 622. An open space is on the other side of the first supporting surface 621. The first supporting element 620 does not have a surface facing the opposite direction to the side surface 622.

The first force application element 630 has a magnetic material to generate a first contact force F1 that keeps the first supporting element 620 in continuous contact with the first middle element 610. The direction of the first contact force F1 is perpendicular to the first supporting surface 621. The main axis OL is parallel to the first supporting surface 621 and the side surface 622.

There is a gap between the second middle element 640 and the second supporting element 650, allowing relative movement between the second supporting element 650 and the second middle element 640. The first supporting element 620 and the second supporting element 650 have an integrally formed structure. The first supporting element 620 and the second supporting element 650 are formed on the main body 110. The second supporting element 650 includes a second supporting surface 652 and a third supporting surface 653. The second supporting surface 652 contacts the second middle element 640 and faces a second direction D2, while the third supporting surface 653 contacts the second middle element 640 and faces a third direction D3.

The second supporting surface 652 and the third supporting surface 653 are not parallel. The angle between the first direction D1 and the second direction D2 is different from the angle between the first direction D1 and the third direction D3. The angle between the first direction D1 and the second direction D2 is smaller than the angle between the first direction D1 and the third direction D3. The angle between the second direction D2 and the third direction D3 accommodates the second middle element 640, so that the second middle element 640 contacts the second supporting surface 652 and the third supporting surface 653.

When viewed along the main axis OL, the distance L2 between the center of the second supporting surface 652 and the center of the optical element 10 is greater than the distance L3 between the center of the third supporting surface 653 and the center of the optical element 10. The arrangement direction of the center of the first middle element 610 and the center of the first force application element 630 is different from the arrangement direction of the center of the second middle element 640 and the center of the second force application element 660.

The second force application element 660 may have magnetic material to generate a second contact force F2 that keeps the second supporting element 650 in continuous contact with the second middle element 640. The direction of the second contact force F2 is neither parallel to nor perpendicular to the second supporting surface 652 and the third supporting surface 653. The direction of the first contact force F1 is different from the direction of the second contact force F2.

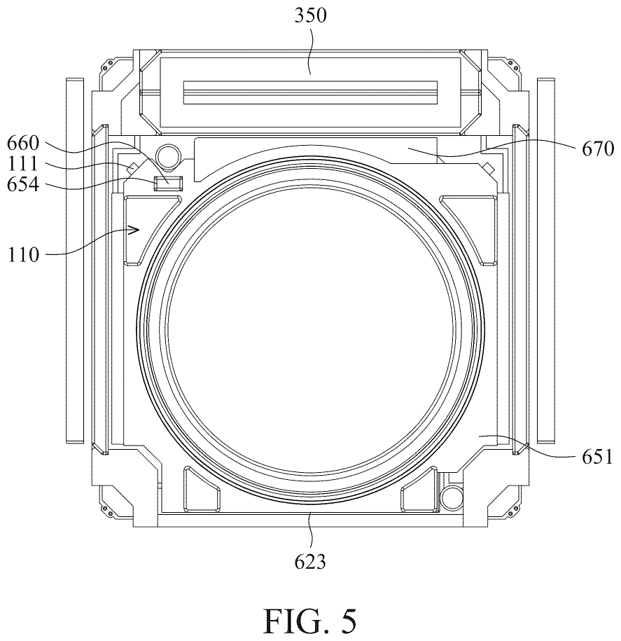

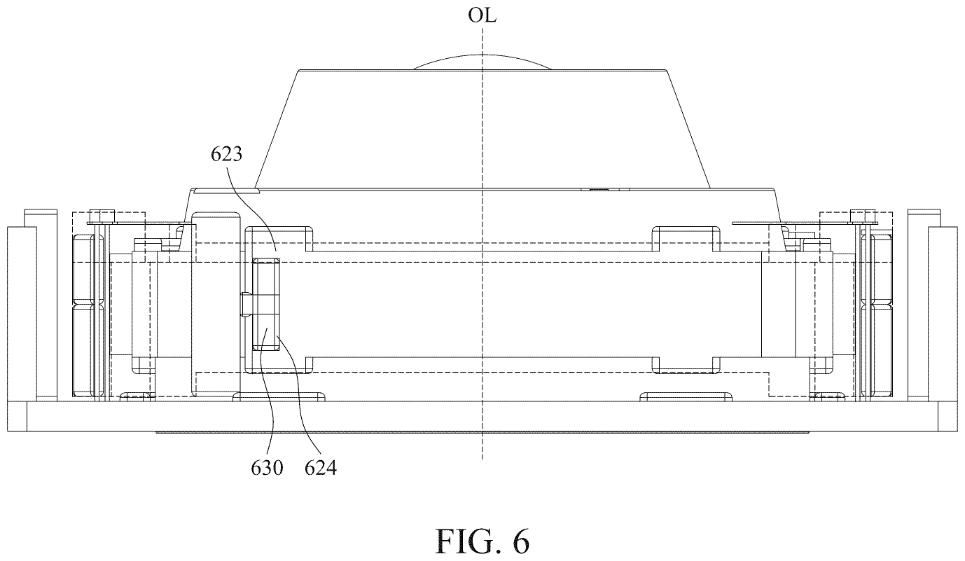

Next, please refer to FIGS. 4, 5, and 6 together. FIG. 5 is a bottom view of the optical element driving mechanism 1, according to certain aspects of the present disclosure. For illustrative purposes, the fixed part 200 is not shown. FIG. 6 is a side view of the optical element driving mechanism 1, according to certain aspects of the present disclosure. For illustrative purposes, the housing 210 is not shown, and the frame 120 is shown in dashed lines.

The supporting assembly 600 further includes a first surface 623, a second surface 651, a first accommodating part 624, and a second accommodating part 654.

The first surface 623 is parallel to the main axis OL, and the first surface 623 and the second surface 651 face different directions. The second surface 651 is perpendicular to the main axis OL.

The first accommodating part 624 accommodates the first force application element 630 and is formed on the first surface 623. The second accommodating part 654 accommodates the second force application element 660 and is formed on the second surface 651.

The fixed element 670 is disposed on the second surface 651 and is fixedly connected to the main body 110 of the movable part 100.

Next, please continue to refer to FIG. 2. The fixed element 670 has a stopper part 671 and a recessed part 672. The stopper part 671 limits the range of movement of the movable part 100 and has a protruding structure.

The recessed part 672 accommodates a control unit 302 of the driving assembly 300. The depth of the recessed part 672 is greater than the thickness of the control unit 302, which has a plate-like structure. When viewed along the main axis OL, the recessed part 672 and the stopper part 671 at least partially overlap.

When viewed along a direction perpendicular to the second surface 651, the fixed element 670 at least partially overlaps the second accommodating part 654.

The driving assembly 300 includes a driving part 301 and a control unit 302. The driving part 301 generates a driving force and is fixedly connected to the movable part 100, as described below. The control unit 302 outputs a driving signal to the driving part 301 and is fixedly connected to the fixed element 670.

The driving part 301 includes two flat plates 305, two first coils 310, two first magnetic elements 320, two second coils 330, two second magnetic elements 340, a third coil 350, a third magnetic element 360, and two fourth coils 370. The first coil 310 and the second coil 330 are embedded in the flat plate 305, forming a set of plate coil.

A first coil 310, a first magnetic element 320, a second coil 330, a second magnetic element 340, and a fourth coil 370 are arranged as a set, and the two sets are disposed on opposite sides of the movable part 100. The following describes the arrangement on one side of the movable part 100, with the coils and magnetic elements on the other side arranged similarly.

The first coil 310 is disposed on the base 220 of the fixed part 200 and includes a first section 311 and a second section 312. The first section 311 and the second section 312 have elongated structures, and the second section 312 is parallel to the first section 311.

The first magnetic element 320 is disposed on the frame 120 and has a first magnetic element surface 321, which faces the first coil 310.

The electromagnetic driving force generated between the first magnetic element 320 and the first coil 310 causes the first magnetic element 320 to move relative to the first coil 310. This may drive the frame 120 to move relative to the base 220, with the frame 120 driving the movement of the main body 110, the fixed element 670, and the optical element 10. Therefore, the electromagnetic driving force generated between the first magnetic element 320 and the first coil 310 may drive the movable part 100 to move relative to the fixed part 200.

The first coil 310 and the first magnetic element 320 drive the movable part 100 to move along a first axis O1, wherein the first axis O1 is perpendicular to the first magnetic element surface 321.

The second coil 330 is disposed on the base 220 of the fixed part 200 and includes a third section 331 and a fourth section 332. The third section 331 and the fourth section 332 have elongated structures, and the third section 331 is parallel to the fourth section 332.

The second magnetic element 340 is disposed on the frame 120 and has a second magnetic element surface 341, which faces the second coil 330.

The first magnetic element surface 321 and the second magnetic element surface 341 face the same direction. The first section 311 is parallel to the third section 331.

The electromagnetic driving force generated between the second magnetic element 340 and the second coil 330 causes the second magnetic element 340 to move relative to the second coil 330. This may drive the frame 120 to move relative to the base 220, with the frame 120 driving the movement of the main body 110, the fixed element 670, and the optical element 10. Therefore, the electromagnetic driving force generated between the second magnetic element 340 and the second coil 330 may drive the movable part 100 to move relative to the fixed part 200 along the first axis O1.

The third coil 350 is disposed on the base 220 of the fixed part 200.

The third magnetic element 360 is disposed on the frame 120 and has a third magnetic element surface 361, which faces the third coil 350.

The electromagnetic driving force generated between the third magnetic element 360 and the third coil 350 causes the third magnetic element 360 to move relative to the third coil 350. This may drive the frame 120 to move relative to the base 220, with the frame 120 driving the movement of the main body 110, the fixed element 670, and the optical element 10. Therefore, the electromagnetic driving force generated between the third magnetic element 360 and the third coil 350 may drive the movable part 100 to move relative to the fixed part 200. The third coil 350 and the third magnetic element 360 drive the movable part 100 to move along a second axis O2, wherein the second axis O2 is parallel to the third magnetic element surface 361.

The first axis O1 and the second axis O2 are perpendicular to each other. The first axis O1 is parallel to the third magnetic element surface 361. The second axis O2 is parallel to the first magnetic element surface 321.

The fourth coil 370 is disposed on the main body 110 of the movable part 100, corresponding to the first magnetic element 320 and the second magnetic element 340.

The electromagnetic driving force generated between the first magnetic element 320 and the fourth coil 370 causes the first magnetic element 320 to move relative to the fourth coil 370. This may drive the frame 120 to move relative to the base 220, with the frame 120 driving the movement of the main body 110, the fixed element 670, and the optical element 10. Therefore, the electromagnetic driving force generated between the first magnetic element 320 and the fourth coil 370 may drive the movable part 100 to move relative to the fixed part 200.

The fourth coil 370 and the first magnetic element 320 drive the optical element 10 and the movable part 100 to move along the main axis OL. The main body 110 contacts the frame 120 through the first middle element 610, the second middle element 640, so the main body 110, the fixed element 670, and the optical element 10 may move relative to the frame 120 along the main axis OL.

The position signal sensed by the position sensing assembly 400 may be transmitted to the control unit 302 through the circuit assembly 500, and the control signal is transmitted through the circuit assembly 500 from the control unit 302 to the driving part 301.

The position sensing assembly 400 is disposed on the fixed element 670 for sensing the movement of the optical element 10 along the main axis OL. The position sensing assembly 400 calculates the movement of the optical element 10 by sensing the magnetic field of the third magnetic element 360.

Next, please continue to refer to FIGS. 2 and 4. The circuit assembly 500 includes a first circuit element 510, a second circuit element 520, a third circuit element 530, a fourth circuit element 540, a first electrical connection part 550, a second electrical connection part 560, and a contact point 570.

The first electrical connection part 550 is at least partially exposed through the first opening 230, and the first circuit element 510 electrically connects the first electrical connection part 550. The driving assembly 300 is electrically connected to the first electrical connection part 550 through the first circuit element 510. The second electrical connection part 560 is at least partially exposed through the second opening 240 (see FIG. 2) and is electrically connected to the first electrical connection part 550 through the first circuit element 510. The driving assembly 300 is electrically connected to the second electrical connection part 560 through the first circuit element 510. The contact point 570 is formed on the second circuit element 520, the position corresponding to the protrusion 111 of the main body 110 of the movable part 100 (see FIG. 5). The driving part 301 is electrically connected to the first circuit element 510 through the contact point 570 of the circuit assembly 500.

Next, refer to FIG. 7. FIG. 7 is a block diagram of the external circuit 700 and the circuit assembly 500 of the optical element driving mechanism 1, according to certain aspects of the disclosure. The external circuit 700 includes a first external assembly 710 and a second external assembly 720. The first electrical connection part 550 is electrically connected to the first external assembly 710, and the second electrical connection part 560 is electrically connected to the second external assembly 720.

Please continue to refer to FIGS. 2 and 4. The shortest distance L5 from the second electrical connection part 560 to the center of the first opening 230 differs from the shortest distance L4 from the first electrical connection part 550 to the center of the first opening 230. The first electrical connection part 550 may move relative to the second electrical connection part 560. The second circuit element 520 is at least partially embedded in the fixed element 670. The first circuit element 510 is electrically connected to the control unit 302 via the first electrical connection part 550 and the third circuit element 530.

The third circuit element 530 and the fourth circuit element 540 have elongated structures and are electrically connect to the first circuit element 510. The third circuit element 530 is electrically connected to the fourth circuit element 540 through the first circuit element 510. When viewed along the main axis OL, the third circuit element 530 and the fourth circuit element 540 do not overlap each other. The extension directions of the third circuit element 530 and the fourth circuit element 540 are parallel to each other.

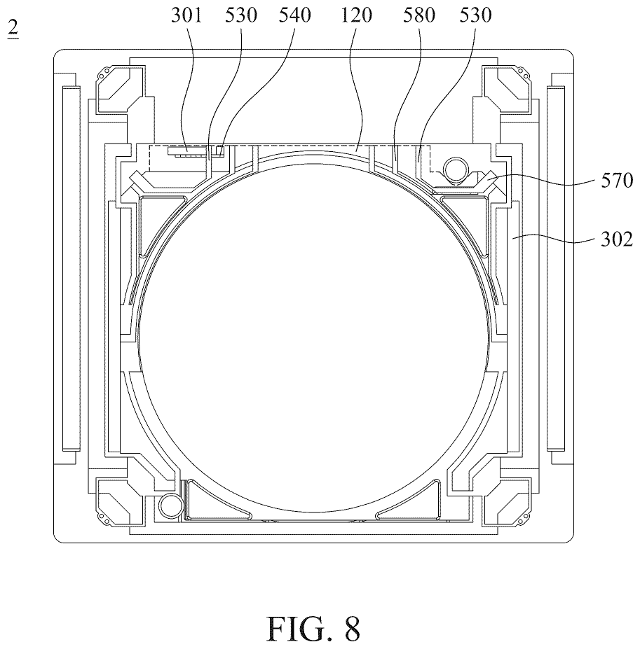

Next, refer to FIG. 8. FIG. 8 is a top view of another optical element driving mechanism 2, according to other aspects of the disclosure. For illustrative purposes, the housing 210 is not shown, and the frame 120 is shown in dashed line. In this embodiment, the circuit assembly 500 further includes a fifth circuit element 580. The driving part 301 is electrically connected to the control unit 302 via the fifth circuit element 580, and the contact point 570 is formed on the third circuit element 530.

In summary, the invention provides an optical element driving mechanism that includes a movable part, a fixed part, a driving element, a position sensing assembly, and a circuit assembly. The movement of the driving assembly drives the movable part to move relative to the fixed part. This allows for the adjustment of the optical element's position to adapt to various external photography needs. Additionally, the multiple coils and magnetic elements of the driving assembly are connected through several circuit elements of the circuit assembly. The multiple connection parts and circuit elements effectively provide sufficient driving force, support the weight of the movable part, stabilize the internal structure, and reduce operational errors of the driving assembly, enabling the optical element to deliver optical imaging that is better and more stable.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments can be made, according to the disclosure herein, without departing from the spirit or scope of the invention. Thus, the breadth and scope of the present invention should not be limited by any of the above described embodiments. Rather, the scope of the invention should be defined, according to the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or claims are intended to be similar to “comprising” is included.

What is claimed is:

1. An optical element driving mechanism, for driving an optical element, comprising:
a fixed part;
a movable part, wherein the movable part moves relative to the fixed part; and
a driving assembly, driving the movable part to move.

2. The optical element driving mechanism as claimed in claim 1, further comprising a supporting assembly, corresponding to the movable part, wherein the supporting assembly includes:
a first middle element, having a magnetic material, or a metal material, or both;
a first supporting element, wherein the first supporting element moves relative to the first middle element, and the first supporting element has:
a first supporting surface, wherein the first supporting surface contacts the first middle element, and faces a first direction; and
a side surface, adjacent to the first supporting surface, wherein the side surface is not parallel to the first supporting surface.

3. The optical element driving mechanism as claimed in claim 2, wherein when viewed along a direction perpendicular to the first supporting surface:
one side of the first supporting surface connects the side surface;
an open space is on the other side of the first supporting surface; and
the first supporting element does not have a surface facing the opposite direction of the side surface.

4. The optical element driving mechanism as claimed in claim 2, wherein the supporting assembly further includes a first force application element,
the first force application element has a magnetic material for generating a first contact force to keep the first supporting element in continuous contact with the first middle element, and the direction of the first contact force is perpendicular to the first supporting surface, wherein a first axis is parallel to the first supporting surface and the side surface.

5. The optical element driving mechanism as claimed in claim 4, wherein the supporting assembly further includes:
a second middle element;
a second supporting element, wherein there is a gap between the second supporting element and the second middle element, and the second supporting element and the second middle element move relative to each other, the first supporting element and the second supporting element have an integrally formed structure, wherein the second supporting element includes:
a second supporting surface, wherein the second supporting surface contacts the second middle element, and faces a second direction; and
a third supporting surface, wherein the third supporting surface contacts the second middle element, and faces a third direction, and the second supporting surface is not parallel to the third supporting surface.

6. The optical element driving mechanism as claimed in claim 5, wherein the angle between the first direction and the second direction is different from the angle between the first direction and the third direction.

7. The optical element driving mechanism as claimed in claim 5, wherein the supporting assembly further includes:
a second force application element, generating a second contact force to keep the second supporting element in continuous contact with the second middle element, the direction of the second contact force is non-parallel and non-perpendicular to the second supporting surface; wherein
the direction of the first contact force is different from the direction of the second contact force.

8. The optical element driving mechanism as claimed in claim 7, wherein when viewed along the first axis:
the distance from the center of the second supporting surface to the center of the optical element is greater than the distance from the center of the third supporting surface to the center of the optical element; and
the arrangement direction of the center of the first middle element and the center of the first force application element is different from the arrangement direction of the center of the second middle element and the center of the second force application element.

9. The optical element driving mechanism as claimed in claim 7, wherein the supporting assembly further includes:
a first surface, parallel to the first axis;
a second surface, wherein the first surface and the second surface face different directions, the second surface is perpendicular to the first axis;
a first accommodation part, formed on the first surface, accommodating the first force application element;
a second accommodation part, formed on the second surface, accommodating the second force application element; and
a fixed element, disposed on the second surface and fixedly connected to the movable part, wherein the fixed element has a stopper part to limit the movement range of the movable part, and the stopper part has a protruding structure.

10. The optical element driving mechanism as claimed in claim 9, wherein:
when viewed along a direction perpendicular to the second surface, the fixed element at least partially overlaps the second accommodation part; and
the angle between the first direction and the second direction is smaller than the angle between the first direction and the third direction.

11. The optical element driving mechanism as claimed in claim 9, wherein the fixed part further includes a first opening, and light passes through the first opening to the optical element.

12. The optical element driving mechanism as claimed in claim 11, wherein the fixed part further includes a second opening, the optical element driving mechanism further comprises a circuit assembly for connecting an external circuit, and the circuit assembly includes:
a first electrical connection part, at least partially exposed through the first opening;
a first circuit element, electrically connected to the first electrical connection part, the driving assembly being electrically connected to the first electrical connection part through the first circuit element; and
a second electrical connection part, at least partially exposed through the second opening, and electrically connected to the first electrical connection part through the first circuit element, the driving assembly being electrically connected to the second electrical connection part through the first circuit element; and
a contact point, corresponding to a protrusion of the movable part.

13. The optical element driving mechanism as claimed in claim 12, wherein:
the external circuit includes a first external assembly and a second external assembly, the first electrical connection part being electrically connected to the first external assembly, and the second electrical connection part being electrically connected to the second external assembly; and
the shortest distance between the second electrical connection part and the first opening is different from the shortest distance between the first electrical connection part and the first opening, and the first electrical connection part moves relative to the second electrical connection part.

14. The optical element driving mechanism as claimed in claim 12, wherein the driving assembly further includes:
a driving part, generating a driving force, fixedly connected to the movable part, and electrically connected to the first circuit element through the contact point; and
a control unit, outputting a driving signal to the driving part, and fixedly connected to the fixed element, wherein the first circuit element is electrically connected to the control unit through the first electrical connection part.

15. The optical element driving mechanism as claimed in claim 14, wherein the circuit assembly further includes a second circuit element, at least partially embedded in the fixed element.

16. The optical element driving mechanism as claimed in claim 15, wherein the fixed element has a recessed part for accommodating the control unit, wherein:
the control unit has a plate-like structure,
the depth of the recessed part is greater than the thickness of the control unit,
when viewed along the first axis, the recessed part at least partially overlaps the stopper part, and the contact point is formed on the second circuit element.

17. The optical element driving mechanism as claimed in claim 15, wherein the circuit assembly further includes:
a third circuit element, having an elongated structure, electrically connected to the first circuit element; and
a fourth circuit element, having an elongated structure, electrically connected to the first circuit element, wherein
the third circuit element is electrically connected to the fourth circuit element through the first circuit element.

18. The optical element driving mechanism as claimed in claim 17, wherein when viewed along the first axis, the third circuit element and the fourth circuit element do not overlap.

19. The optical element driving mechanism as claimed in claim 17, wherein the extension direction of the third circuit element is parallel to the extension direction of the fourth circuit element.

20. The optical element driving mechanism as claimed in claim 17, further including a vibration suppression element, directly contacting the third circuit element and the fourth circuit element, having a resin material, wherein:
the circuit assembly further includes a fifth circuit element, and the driving part is electrically connected to the control unit through the fifth circuit element; and
the contact point is formed on the third circuit.
